(19) United States
(12) Patent Application Publication
(10) Pub. No.: US 2025/0179786 A1
(43) Pub. Date: Jun. 5, 2025

(54) TOILET BOWL DISCHARGE ASSEMBLY

(71) Applicant: FLUIDMASTER, INC., San Juan Capistrano, CA (US)

(72) Inventors: Jack Nguyen, San Juan Capistrano, CA (US); Krishnaditya Arkalgud, San Juan Capistrano, CA (US); Gabriel Wong, San Juan Capistrano, CA (US)

(21) Appl. No.: 19/049,613

(22) Filed: Feb. 10, 2025

Related U.S. Application Data
(63) Continuation of application No. PCT/US23/29972, filed on Aug. 10, 2023.
(60) Provisional application No. 63/397,081, filed on Aug. 11, 2022.

(51) Int. Cl. E03D 11/16

(52) U.S. Cl. CPC E03D 11/16

(57) ABSTRACT

The disclosure describes a system for sealing a discharge of a toilet bowl according to some embodiments. In some embodiments, the system includes one or more gaskets that are not wax. In some embodiments, the system includes a plurality of gaskets that are configured to be stacked on top of each other. In some embodiments, the system includes a spacer that is configured to be assembled between two gaskets to add rigidity to the assembled structure. In some embodiments, one or more gaskets and/or spacers include a fastener to prevent movement of the assembled structure. In some embodiments, a spacer includes one or more ribs and/or rings configured to seal against a gasket.

### CROSS-REFERENCE TO RELATED APPLICATIONS

This application is a Continuation Application related to and claiming the benefit of commonly owned, co-pending PCT International Application No. PCT/US2023/029972, filed Aug. 10, 2023, which claims priority to and the benefit of U.S. Provisional Patent Application No. 63/397,081, filed on Aug. 11, 2022, entitled “TOILET BOWL GASKET,” the contents of which are incorporated herein by reference in their entirety.

### BACKGROUND

Traditional seals for toilets include wax which deform to the shape of contact surfaces to provide a seal. However, these seals are limited in their ability to conform to surfaces which move and the seals are messy to handle. Additionally, removing and reinstalling a toilet typically requires removing the old seal which can be very messy and unsanitary, and reinstallation requires purchasing and installing a new seal. While some prior art devices use deformable materials other than wax, those devices are often difficult to manufacture with high quality, have complex shapes, and are relatively expensive. Therefore, there is a need in the art for a toilet sealing device which overcomes one or more of these disadvantages.

### SUMMARY

In some embodiments, the disclosure is directed to system for sealing a toilet bowl discharge. In some embodiments, the system includes one or more of a first gasket, a spacer, and a second gasket. In some embodiments, the system is configured to create a seal between the toilet bowl discharge and a floor flange when system is assembled with the spacer between the first gasket and the second gasket. In some embodiments, the spacer comprises a stiffness greater than the first gasket and the second gasket. In some embodiments, the first gasket is thicker than the second gasket. In some embodiments, the first gasket comprises two gaskets stacked on each other.

In some embodiments, the spacer comprises one or more spacer sidewalls. In some embodiments, the one or more spacer sidewalls are configured to define a recess. In some embodiments, one or more spacer sidewalls are configured to at least partially surround and/or overlap one or more gasket sidewalls. In some embodiments, the spacer comprises one or more ribs. In some embodiments, the one or more ribs extend around a perimeter of the spacer. In some embodiments, the one or more ribs define one or more rings on a surface of the spacer.

In some embodiments, the one or more rings include a discharge seal ring, an intermediate seal ring, and a perimeter seal ring. In some embodiments, the first gasket and/or the second gasket is configured to at least partially deform to conform to a shape of the one or more rings.

In some embodiments, the spacer comprises one or more gaps. In some embodiments, the one or more gaps are configured to enable the first gasket to contact the second gasket when the spacer is in between the first gasket and the second gasket. In some embodiments, at least one of the first gasket, the second gasket, and the spacer comprises a bowl discharge cutout comprising a funnel shape. In some embodiments, the first gasket, the second gasket, and the spacer each comprises one or more fastener cutouts which are aligned when the spacer is assembled between the first gasket and the second gasket.

In some embodiments, the system is directed to a method for creating a discharge seal assembly. In some embodiments, the method includes a step of providing a first gasket, a spacer, and/or a second gasket. In some embodiments, a step includes assembling the spacer between the first gasket and the second gasket to create the discharge seal assembly. In some embodiments, a step includes coupling the discharge assembly to a floor flange. In some embodiments, a step includes coupling the discharge assembly to a toilet bowl discharge.

In some embodiments, a step includes coupling the first gasket, the spacer, and the second gasket together using a fastener. In some embodiments, coupling the discharge assembly to the floor flange includes a step of passing a fastener through a first gasket cutout, a spacer cutout, and/or a second gasket cutout. In some embodiments, the fastener is secured to the floor flange.

In some embodiments, the disclosure is directed to a kit for creating a discharge seal assembly. In some embodiments, the kit includes at least a first gasket, a spacer, and a second gasket. In some embodiments, the spacer comprises a spacer outer perimeter that includes a shape that is substantially similar to both a first gasket outer perimeter of the first gasket and a second gasket outer perimeter of the second gasket. In some embodiments, the first gasket, the spacer, and the second gasket are configured to be stacked together to create a seal for a toilet discharge. In some embodiments, the kit includes shims configured to stabilize a toilet installed on an uneven floor. In some embodiments, the kit includes a third gasket. In some embodiments, the third gasket includes a third gasket outer perimeter shape with a different shape than the first gasket outer perimeter and the second gasket outer perimeter. In some embodiments, the first gasket, the spacer, and the third gasket are configured to be stacked together to create a seal for a toilet discharge. In some embodiments, the first gasket comprises a different thickness than the second gasket and/or the third gasket.

### DRAWING DESCRIPTION

FIG. 1 illustrates an isometric view of a multi-sided, compressible toilet bowl gasket for sealing a toilet bowl discharge to prevent leakage to a floor according to some embodiments.

FIG. 2 illustrates an isometric view of the system with two, multi-sided, compressible toilet bowl gaskets configured to seal a toilet bowl discharge according to some embodiments.

FIG. 3 illustrates an isometric view of two multi-sided, compressible toilet bowl gaskets and a rigid spacer for sealing a toilet bowl discharge to prevent leakage to a floor according to some embodiments.

FIG. 4 illustrates a partial sectional view of the toilet bowl gaskets and rigid spacer shown in FIG. 3 according to some embodiments.

FIG. 5 illustrates an isometric view of one or more different gasket configurations that are included in a kit according to some embodiments.

FIG. 6 illustrates an isometric view of a rigid spacer according to some embodiments.

FIG. 7 depicts a view of a gapped spacer according to some embodiments.

FIG. 8 shows a funnel discharge cutout configuration according to some embodiments.

FIG. 9 shows a funnel spacer configuration according to some embodiments.

FIG. 10 illustrates a kit comprising one or more first thickness gaskets, one or more second thickness gaskets, one or more fitted gaskets, one or more mounting hardware, one or more toilet shims, and/or one or more spacers according to some embodiments.

FIG. 11 shows the one or more hardware including one or more mounting screws, one or more plastic washers, one or more mounting screw nuts, and/or one or more steel washers.

FIG. 12 depicts an assembly process which includes three gaskets from the kit according to some embodiments.

FIG. 13 illustrates shim installation according to some embodiments.

FIG. 14 illustrates a spacer which includes one or more gripping embossments according to some embodiments.

### DETAILED DESCRIPTION

In some embodiments, the disclosure is directed to systems and methods for sealing waste drain conduits, such as plumbing fixtures (e.g., toilets) to waste drain conduits. In some embodiments, the system includes a flange. In some embodiments, the system includes one or more specially configured compressible gaskets, rigid spacers 301, and/or toilet floor flanges according to some embodiments. In some embodiments, the system is configured to provide a sealed connection between a toilet and a water waste drainpipe. In some embodiments, the system is configured to provide a mounting surface between a water closet (toilet bowl) and a supporting floor surface and/or a flange. As used herein, the term “rigid” and similar terms used herein include materials and components which are less than completely rigid (i.e., undeformable without at least some before permanent plastic deformation) which may include the ability for one corner and/or side to bend up to about 30 degrees relative to an opposite corner and/or side before permanent plastic deformation occurs.

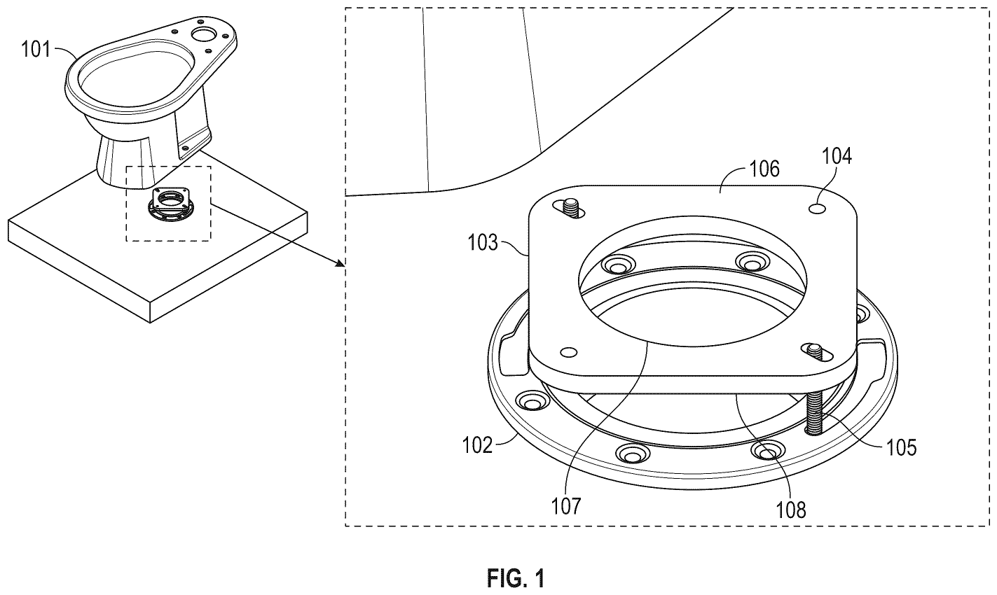

FIG. 1 illustrates an isometric view of a multi-sided, compressible toilet bowl first gasket 103 for sealing a toilet bowl discharge to prevent leakage to a floor according to some embodiments. In some embodiments, the first gasket 103 comprises one or more fastener cutouts 104 configured to enable floor mounting fasteners 105 to pass therethrough. In some embodiments, the one or more fastener cutouts 104 are elongated fastener cutouts 202 (e.g., slot shaped), where the one or more elongated fastener cutouts 202 have a length greater than a width when viewing the top surface of the first gasket 103, which gives the system positional adjustment over floor flange 102 and/or discharge pipe in some embodiments. In some embodiments, the one or more symmetrical fastener cutouts 204 are circular and/or have an equal radius from all sides relative to an origin located at a center axis passing through the symmetrical fastener cutout 204 from the top surface to the bottom surface.

In some embodiments, the first gasket 103 includes at least two fastener cutouts 203, 204. In some embodiments, the gasket 103 includes one or more elongated gasket cutouts 203 and/or or one or more symmetrical gasket cutouts 204. In some embodiments, at least one symmetrical gasket cutout 204 comprises a circular shape and at least one elongated gasket cutout 203 comprise a slot shape. In some embodiments, at least one gasket cutout does not comprise a round shape. In some embodiments, at least one fastener cutout 104 is disposed proximate to a corner and/or edge of the top and/or bottom gasket surfaces. In some embodiments, the gasket 103 includes at least two fastener cutouts 104 at opposing corners and/or edges of the top and/or bottom surfaces. In some embodiments, the at least two fastener cutouts 104 at opposing corners and/or edges are positioned such that a geometrical center of each fastener cutout 104 lies on the same vertical plane, where the vertical plane is defined perpendicular to the top surface 106 and/or bottom surface (opposite side, not shown).

In some embodiments, the gasket 103 includes a bowl discharge cutout 107 for toilet bowl 101 configured to enable a toilet waste discharge (bottom of bowl 101, not shown) to pass therethrough. In some embodiments, the bowl discharge cutout 107 is greater than or equal to 2 inches. In some embodiments, the bowl discharge cutout 107 comprises a round shape. In some embodiments, the bowl discharge cutout 107 is not a round shape. In some embodiments, the gasket 103 is configured to be placed between a top of the floor flange 102 and the bottom of a toilet bowl 101. In some embodiments, the gasket 103 includes a top surface 106 and bottom surface where the at least two cutouts are formed perpendicular to the top surface 106 and bottom surface.

In some embodiments, the gasket 103 includes one or more sidewalls 108. In some embodiments, the gasket 103 includes at least four gasket sidewalls 108 extending perpendicular from the top surface 106 and/or bottom surface, the four gasket sidewalls 108 defining a thickness of the gasket 103. In some embodiments, a first gasket sidewall and third gasket sidewall of the four gasket sidewalls extend parallel to each other along a horizontal plane. In some embodiments, the horizontal plane is defined by the top and/or bottom surfaces of the gasket. In some embodiments, the first gasket sidewall and the third gasket sidewall are perpendicular to a second gasket sidewall and/or fourth gasket sidewall along the horizontal plane. In some embodiments, the system includes a single gasket 103. In some embodiments, the system includes a plurality of gaskets 201, 202 and/or spacers 301, where the spacers 301 comprise a rigidity greater than the gaskets.

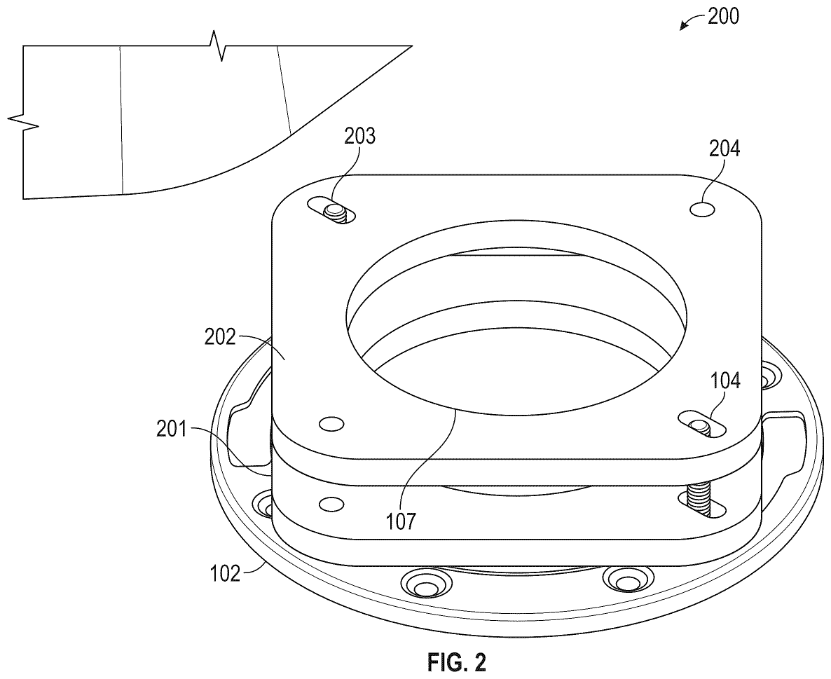

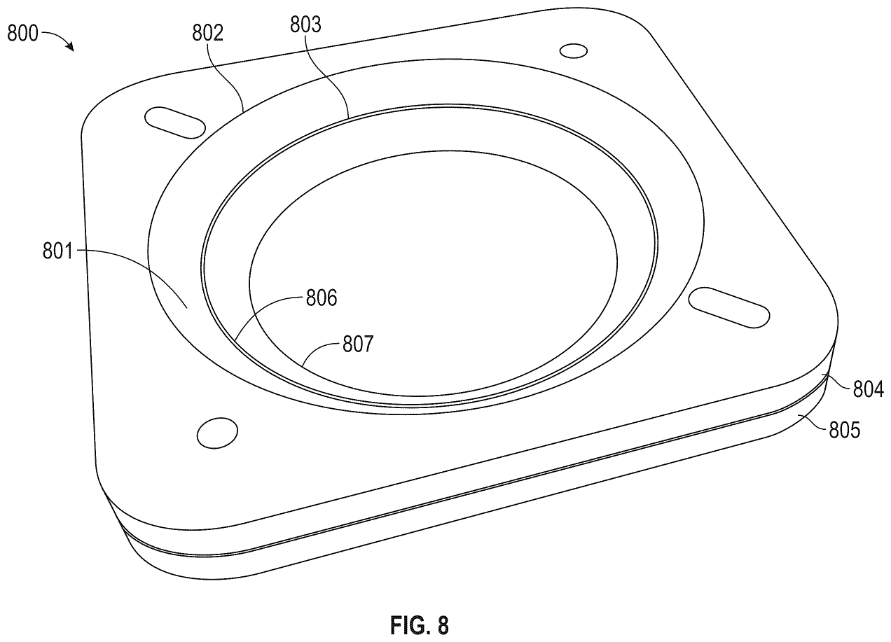

FIG. 2 illustrates an isometric view 200 of the system with two, multi-sided, compressible toilet bowl first gaskets 201, 202 configured to seal a toilet bowl discharge to prevent leakage to a floor according to some embodiments. In some embodiments, a first gasket 201 and a second gasket 202 are identical in shape, size, and/or location of one or more fastener cutouts 104. In some embodiments, one or more bowl discharge cutouts 107 include an inward sloping wall 801, where the top surface opening 802 is larger than the bottom surface opening 803. In some embodiments, the bowl discharge cutout 107 inward sloping wall 801 forms a funnel shape (see FIG. 8).

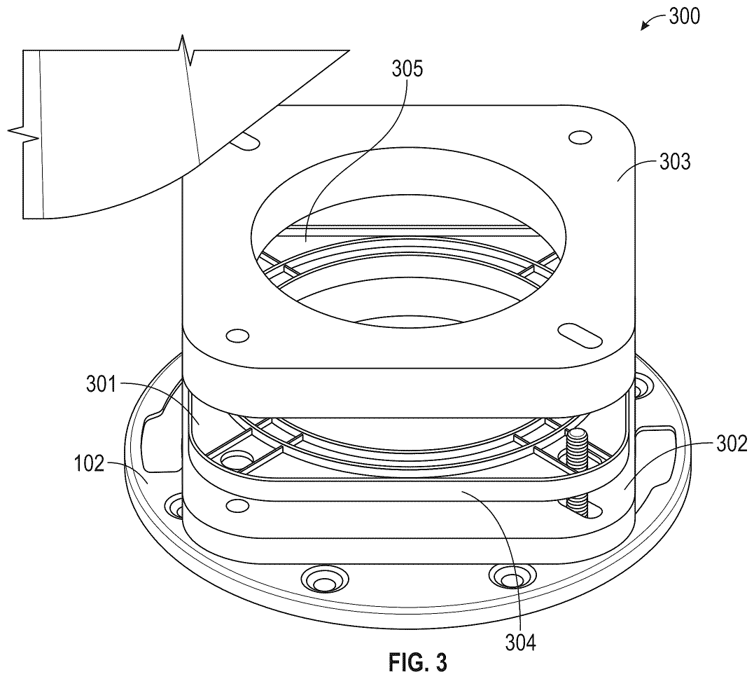

FIG. 3 illustrates an isometric view 300 of two multi-sided, compressible toilet bowl gaskets and a rigid spacer 301 for sealing a toilet bowl discharge to prevent leakage to a floor according to some embodiments. In some embodiments, a first thickness gasket 303 comprises a thickness greater than a second thickness gasket 302 and/or a rigid spacer 301. In some embodiments, the first thickness gasket 303 is a single gasket. In some embodiments, the first thickness gasket includes a plurality of gaskets 201, 202. In some embodiments, at least one gasket described herein is configured to be compressed up to 80% of its thickness. In some embodiments, at least one gasket is configured to be compressed up to 50% of its thickness. In some embodiments, at least one gasket is configured to be compressed up to 20% of its thickness.

In some embodiments, at least one substantially rigid spacer 301 is configured to be compressed less than 1% of its thickness when a gasket is compressed more than 10% of its thickness. In some embodiments, the system comprises two or more gaskets, where at least one gasket is configured to be compressed a different percentage of its thickness than another gasket. In some embodiments, two or more gaskets configured to be stacked together each have the same thickness and/or the same physical properties (e.g., hardness, flexibility, permeability, etc.). In some embodiments, two or more gaskets configured to be stacked together each have a different thickness and/or different physical properties. In some embodiments, one or more gaskets are made from closed-cell foam material. In some embodiments, one or more gaskets are made from an elastomer material.

In some embodiments, the system includes one or more rigid spacers 301. In some embodiments, the one or more rigid spacers 301 are configured to be positioned between two or more stacked gaskets. In some embodiments, a rigid spacer 301 is substantially incompressible. In some embodiments, a perimeter of a rigid spacer 301 as defined by one or more rigid spacer sidewalls 304 an inner perimeter of which are substantially equal to a perimeter defined by gasket sidewalls 108. In some embodiments, one or more rigid spacer sidewalls 304 are configured to define a recess 305, wherein one or more spacer sidewalls 304 are configured to at least partially surround and/or overlap one or more sidewalls 108 of a gasket 103. In some embodiments, the underside of spacer 301 is a reflection of the top side, where a top side and a bottom side of one or more rigid spacers 301 comprises one or more rigid spacer 301 sidewalls are configured to define a recess which at least partially surrounds and/or overlaps one or more sidewalls 108 of a gasket 103 (and/or 302, 303).

In some embodiments, the spacer 301 comprises one or more ribs 601 defining one or more seal rings 602, 603, 604. In some embodiments, one or more rigid spacers 301 include a substantially raised-sections member 401 defining top and bottom sides of one or more perimeter seal rings 60s, 603, 604. In some embodiments, the perimeter seal ring 604 and/or the discharge seal ring 602 are configured to make a continuous perimeter contact with a respective top and/or bottom gasket surface to form a leak tight seal under normal operating conditions when placed in-between toilet bowl gaskets.

In some embodiments, the system includes two or more gaskets 201, 202, 302, 303 configured to be stacked together to form a thicker gasket assembly for sealing a toilet bowl 101 installed to the floor flange 102 of a water waste drainpipe. In some embodiments, the system includes two or more gaskets 302, 303 and a rigid spacer 301 configured to be stacked together to form a thicker gasket assembly for sealing a toilet bowl 101 installed to the floor flange of the water waste drainpipe. This enables sealing for a range of heights for situations where, as a non-limiting example, a floor flange 102 was installed on a subfloor, and the flooring above causes an excessive gap between the floor flange 102 and the toilet discharge according to some embodiments.

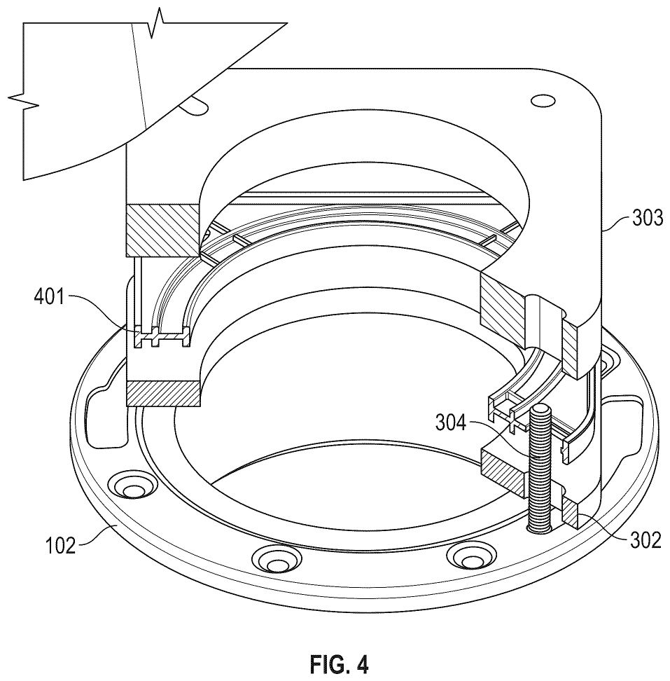

FIG. 4 illustrates a partial sectional view of the toilet bowl gaskets and rigid spacer 301 shown in FIG. 3 according to some embodiments. In some embodiments, the top surface and/or the bottom surface of the gasket and/or the rigid spacer 301 comprises an adhesive. In some embodiments, the adhesive is configured to secure a gasket to the rigid spacer 301. In some embodiments, the adhesive is configured to prevent lateral movement of the one or more gaskets and/or to maintain alignment of one or more gaskets with one or more of a rigid spacer 301, a toilet discharge, a floor surface, another gasket, and a flange surface.

In some embodiments, the top and/or the bottom surface of a gasket 302, 303 and/or a rigid spacer 301 includes one or more gasket fasteners 901 and/or one or more spacer fasteners 902 configured to secure and/or align one gasket to another and/or one or more gaskets to the spacer 301. In some embodiments, a gasket fastener 901 and/or a spacer fastener 902 comprise one or more embossments and/or protrusions on one or more rigid spacers 301 and/or one or more gaskets 903, 904. In some embodiments, the one or more embossments and/or protrusions are configured to mate with one or more cutouts 104 and/or recesses in one or more gaskets and/or rigid spacers 301. In some embodiments, the one or more fasteners 901, 902 are configured to prevent lateral movement of two or more gaskets (e.g., first sloped wall gasket 903 and second sloped wall gasket 904) and/or to maintain alignment of one or more gaskets with a rigid spacer 301 (e.g., sloped wall spacer 901). In some embodiments, any gasket and/or spacer described herein comprises one or more gasket fasteners 901 and/or one or more spacer fasteners 902, respectively.

In some embodiments, a gasket comprises at least two gasket fasteners 901 each configured to mate with a fastener cutout 104 to prevent relative movement between gaskets and/or a gasket spacer stack. In some embodiments, a substantially rigid spacer 301 (and/or gapped spacer 701) comprises at least two spacer fasteners 902 each configured to mate with a fastener cutout 104 to prevent relative movement between gaskets and/or a gasket spacer stack. In some embodiments, a substantially rigid spacer 301 (701) comprises at least four spacer fasteners 902 each configured to mate with a fastener cutout 104 to prevent relative movement between gaskets and/or a gasket spacer stack. In some embodiments, two of the four spacer fasteners 902 are secured to a top surface of a spacer 301, 701, and/or two of the four spacer fasteners 902 are secured to a bottom portion of the a spacer 301, 701. In some embodiments, the spacer fastener 902 and/or gasket fastener 901 is integral. In some embodiments, the spacer fastener 902 and/or gasket fastener 901 is separable.

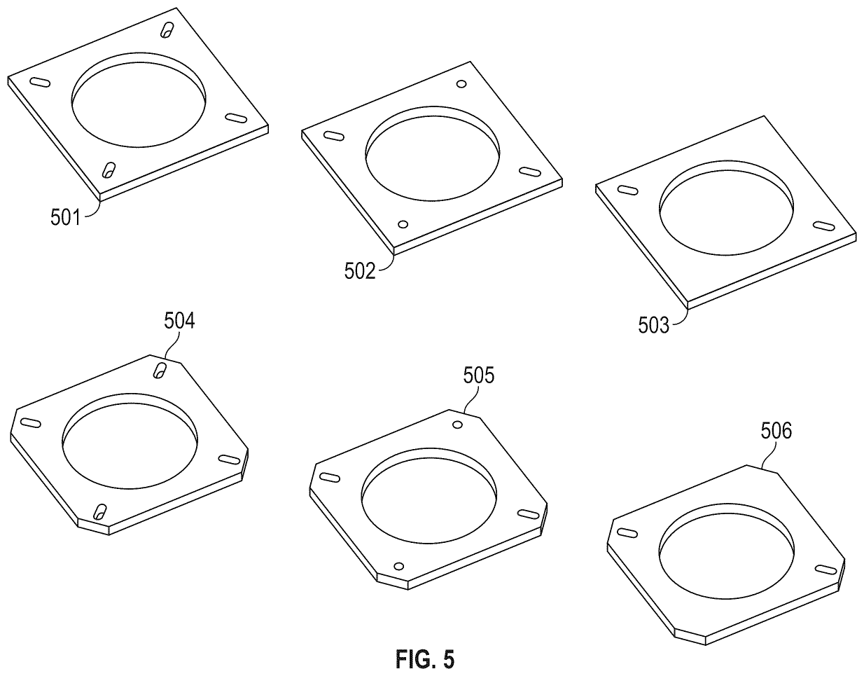

FIG. 5 illustrates an isometric view of one or more different gasket configurations that are included in a kit according to some embodiments. In some embodiments, the outer perimeter of the top and/or bottom surface of one or more gaskets 501, 502, 503, forms a square shape or a rhombus shape. In some embodiments, the outer perimeter of the top and/or bottom surface of one or more gaskets 504, 505, 506 are not a round shape. In some embodiments, the one or more gaskets comprise a top and/or bottom shape that includes one or more of a rhombus shape, an oval shape, and/or a circular shape. In some embodiments, the one or more gaskets include one or more sidewalls extending perpendicular from the top and/or bottom surface. In some embodiments, the corners of adjoining sides of the gasket are rounded and/or configured to be trimmed off. In some embodiments, one or more gaskets do not include cutouts.

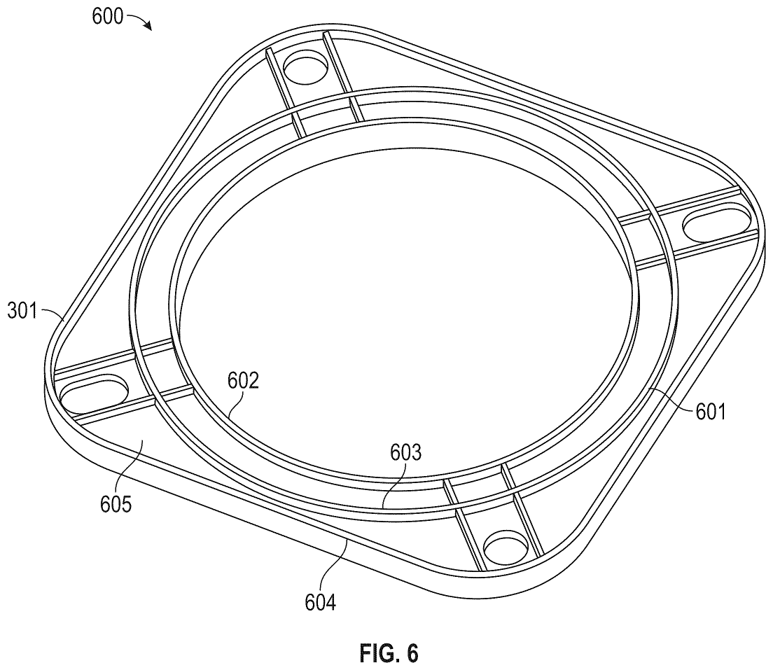

FIG. 6 illustrates an isometric view 600 of a substantially rigid spacer 301 according to some embodiments. In some embodiments, a substantially rigid spacer 301 comprises one or more ribs 601 comprising one or more raised sections configured to engage and/or deform one or more gaskets, wherein at least a portion of the one or more gaskets are configured to conform to a shape of the one or more ribs 601. In some embodiments, the one or more ribs 601 extend to create one or more rings. In some embodiments, a substantially rigid spacer 301 comprises one or more of a discharge seal ring 602, an intermediate seal ring 603, and a perimeter seal ring 604. The term “ring” as used herein does not convey any particular shape but describes continuous structure around a perimeter. In some embodiments, a substantially rigid spacer 301 comprises a solid upper and lower surface 605 configured to separate the surfaces of two gaskets (e.g., 302, 303) coupled to either side.

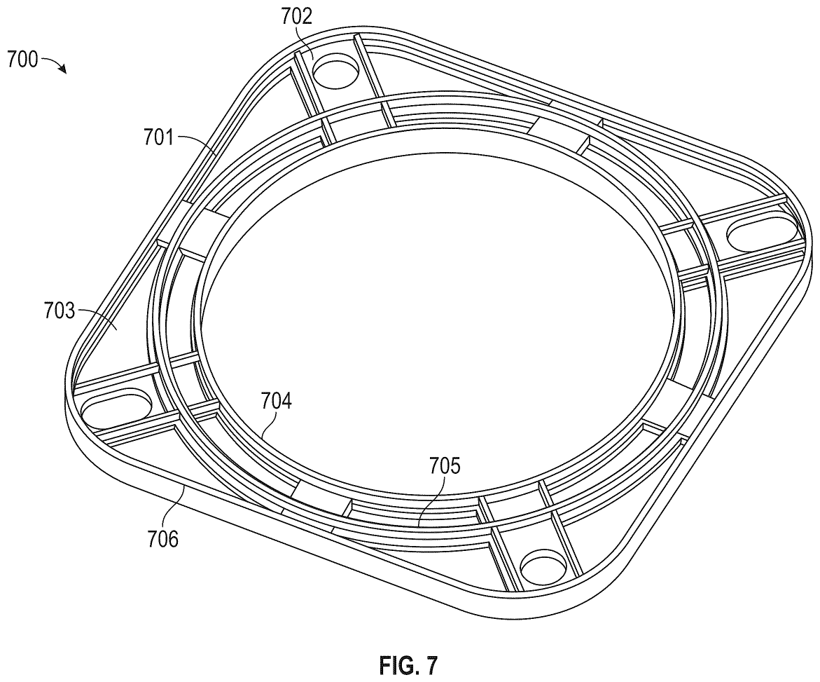

FIG. 7 depicts a view 700 of a gapped spacer 701 according to some embodiments. In some embodiments, gapped spacer 701 comprises one or more gaps 703 configured to enable at least part of the surfaces of two gaskets (e.g., 201, 202) to contact each other when coupled to the gapped spacer 701. In some embodiments, one or more gaskets comprise an adhesive on their upper and/or lower surfaces that bond the two gaskets to each other across the gaps 703 in the gapped spacer 701. In some embodiments, the gapped spacer 701 includes one or more mounting bridge 702 configured to support one or more ribs and/or rings. In some embodiments, one or more mounting bridges 702 include one or more cutouts configured to enable a mounting screw to pass therethrough. In some embodiments, one or more mounting bridges 702 do not include cutouts.

Similar to substantially rigid spacer 301, in some embodiments, a spacer 701 comprises one or more of a discharge seal ring 704, an intermediate seal ring 705, and a perimeter seal ring 706 which perform a similar function.

FIG. 8 shows a funnel discharge cutout configuration 800 according to some embodiments. In some embodiments, the system includes one or more of a first funnel gasket 804 and second funnel gasket 805 each comprising a center gasket cutout inward sloping wall 801. In some embodiments, the first funnel gasket 804 comprises a first top opening 802 at a first top surface is larger than a first bottom opening 803 at a first bottom surface. In some embodiments, the second funnel gasket 805 comprises a second top opening 806 at the top surface that is substantially the same dimension as the first bottom opening 803 at the bottom surface of the first gasket. In some embodiments, the second gasket has a second bottom opening 807 at the bottom surface that is smaller than the second top opening 806 at the top surface. In some embodiments, a funnel shape is formed from each center gasket cutout when the first gasket is laid on top of the second gasket as illustrated in FIG. 8. In some embodiments, this funnel shape enables leak free connections when a toilet bowl discharge size does not match the size of a discharge pipe in a floor. In some embodiments, the system includes at least one funnel gasket 804 and at least one perpendicular wall gasket 103.

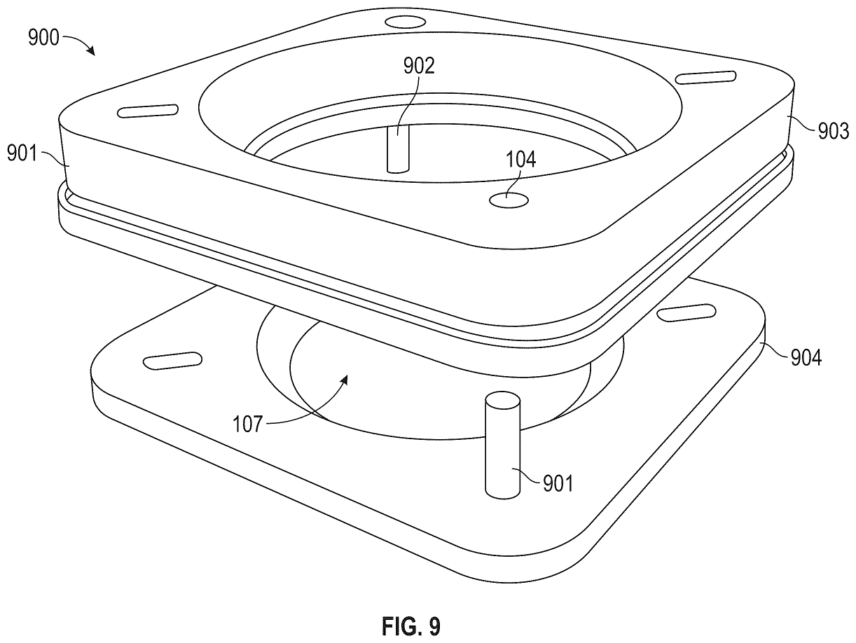

FIG. 9 shows a funnel spacer configuration 900 according to some embodiments. In some embodiments, the system includes at least one sloped wall spacer 901 according to some embodiments. In some embodiments, a center cutout in the sloped wall spacer 901 is substantially the same shape as the first bottom opening 803 and/or the second top opening 806. In some embodiments, a first sloped wall gasket 903 includes a first top opening 802 and a first bottom opening 803 comprising a first bottom diameter less than a first top opening 802, forming a first funnel shape. In some embodiments, a second sloped wall gasket 904 includes a second top opening 806 substantially equal in diameter to the first bottom opening 803.

In some embodiments, the second sloped wall gasket 904 includes a second bottom opening 807 comprising a second bottom diameter that is less than the second top opening 806. In some embodiments, the system is configured to form a continuous funnel shape when the first sloped wall gasket 903 is stacked on top of the second sloped wall gasket 904 and/or stacked on the sloped wall spacer. In some embodiments, the sloped wall spacer 901 comprises sloped walls in the bowl discharge cutout 107. In some embodiments, the sloped wall spacer 901 does not comprise sloped walls. In some embodiments, the sloped wall spacer 901 instead comprises vertical walls and/or comprises the rigid spacer 301 or the gapped spacer 701. A straight wall spacer such as rigid spacer 301 and/or gapped spacer 701 works well with the funnel discharge cutout configuration 800 according to some embodiments. In some embodiments, a first sloped wall gasket 903 includes a first funnel gasket 804 and a second funnel gasket 805 stacked on each other (see FIG. 8).

In some embodiments, the system includes a toilet bowl gasket kit that comprises one or more gaskets 103, 201, 202, 302 303, 804, 805, 903, 904, one or more spacers 301, 701, 901, and/or any combination of the one or more components shown in FIGS. 1-9. In some embodiment, the toilet bowl gasket kit is configured to create a substantially leak-proof seal between a toilet bowl discharge opening and a drainpipe installed to the floor as described herein. In some embodiments, the kit comprises one or more mounting hardware for securing the toilet bowl 101 to a floor flange. In some embodiments, the system and/or kit includes one or more rigid shims configured to provide support for maintaining a distance between a toilet bottom surface and a floor. In some embodiment, the mounting hardware is configured to secure the toilet bowl 101 to the floor and/or floor flange 102. In some embodiments, the mounting hardware comprises one or more mounting screws configured to secure the toilet to the floor flange 102 when the floor flange top surface is below a floor surface.

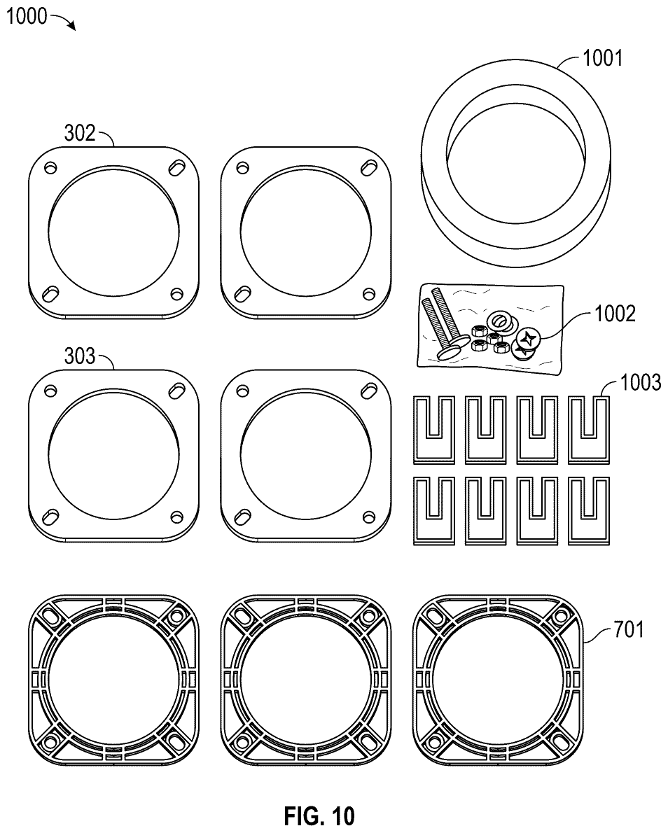

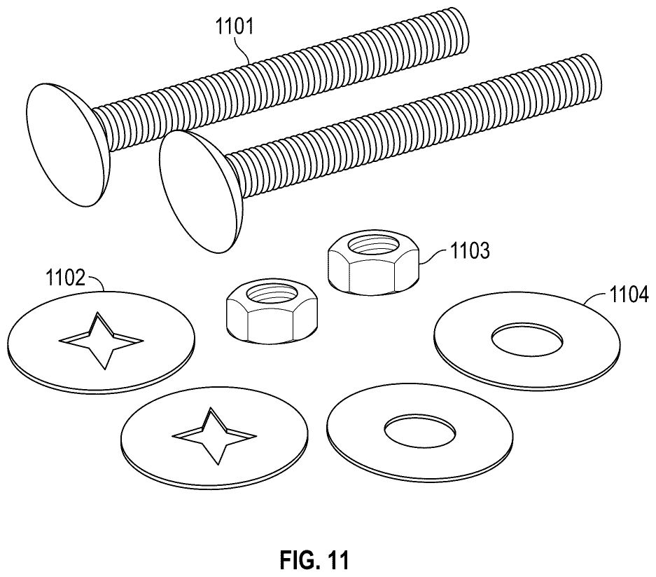

FIG. 10 illustrates a kit 1000 comprising one or more first thickness gaskets 302, one or more second thickness gaskets 303, one or more fitted gaskets 1001, one or more mounting hardware 1002, one or more toilet shims 1003, and/or one or more spacers 1003, and one or more gapped spacers 701 according to some embodiments. In some embodiments, the kit 1000 can include any combination of two or more of items in FIG. 10. FIG. 11 shows details of the hardware 1002 including one or more mounting screws 1101, one or more plastic washers 1102, one or more mounting screw nuts 1103, and/or one or more steel washers 1104.

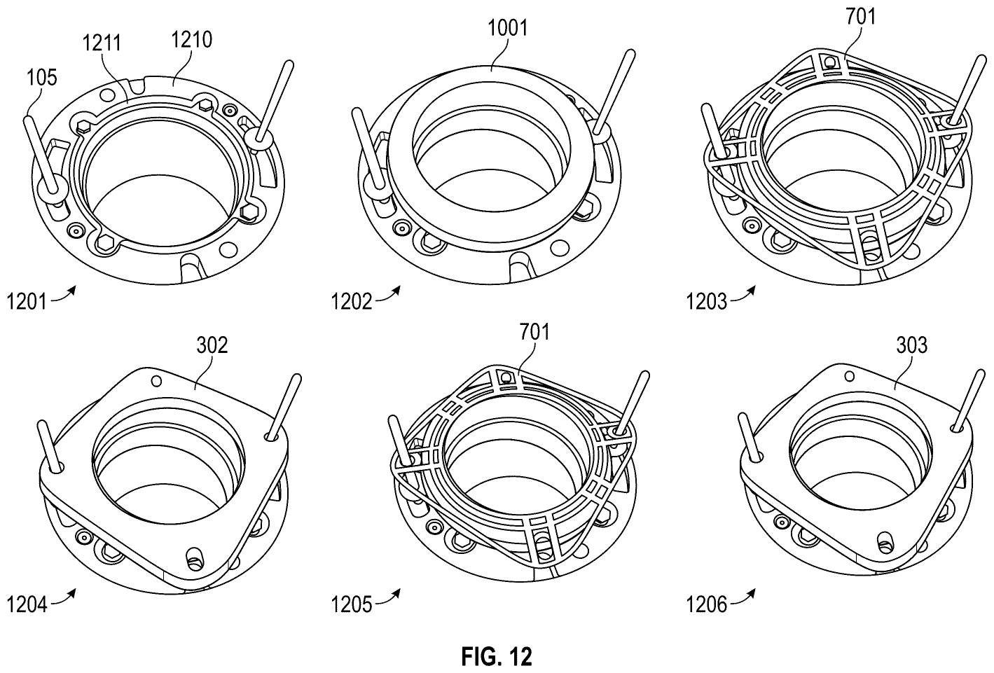

FIG. 12 depicts an assembly process which includes three gaskets from the kit 1000 according to some embodiments. In some embodiments, a method of installation starts with mounting screws 1101 being installed into a cast iron floor flange 1210. In some embodiments, a floor flange 1210 includes a flange rim 1211 that is at least partially recessed into the floor flange 1210. Advantageously, at least one gasket in the kit (e.g., fitted gasket 1001) is shaped to engage an inner portion of the flange rim 1211 on all sides according to some embodiments. In some embodiments, the fitted gasket 1001 includes a round shape from a top view and a rectangular cross-section from a side view, relative to the floor. In some embodiments, fitted gasket 1001 is configured to engage a bottom portion of the flange rim 1211 while at least partially rising above a top portion of the flange rim 1211, thereby creating a completely or substantially watertight seal.

At step 1203, in some embodiments, a gapped spacer 701 is installed on top of fitted gasket 1001 to add rigidity to the structure. Although a gapped spacer 701 is used in this non-limiting example, a rigid spacer 301 can alternatively be used depending on the application. In some embodiments, the kit 1000 include one or more rigid spacers 301. In some embodiments, the fitted gasket 1001 includes one or more sidewalls configured to engage the perimeter seal ring 706 (or 604), thereby aiding in movement prevention.

At step 1204, in some embodiments, a first thickness gasket 302 is placed on top of the gapped spacer 701. In some embodiments, at step 1205 a second gapped spacer 701 (or rigid spacer) is placed on the first thickness gasket 302. At step 1206, a second thickness gasket 303 (or a first thickness gasket, depending on the desired height and/or application) is inserted on the second gapped spacer 701. In some embodiments, the fitted gasket 1001 is prevented from moving by the flange rim 1211 and/or mounting screws 105, while the first gasket 302 and/or second gasket 303 are prevented from moving by engagement with mounting screw 105 and/or engagement with fitted gasket 1001.

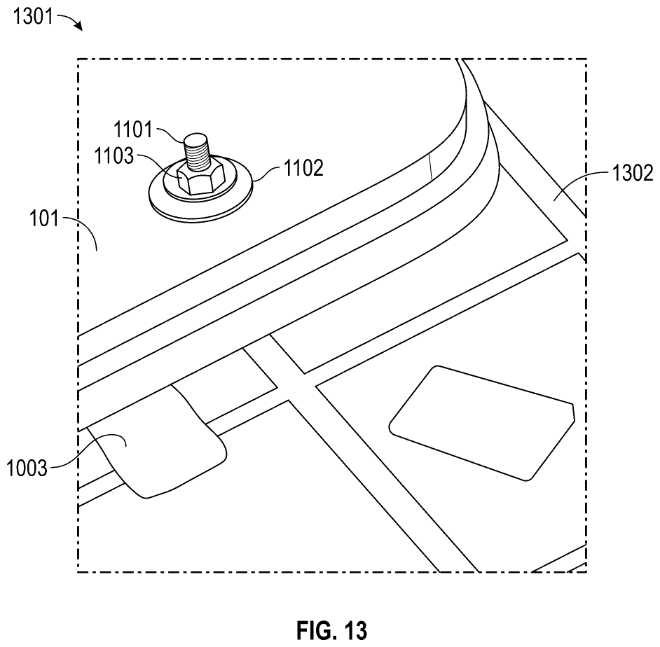

FIG. 13 illustrates a shim 1003 installation according to some embodiments. In some embodiments, a step 1301 includes placing one or more shims 1003 under a mounted toilet 101 to fill the gap between the toilet 101 base and an uneven floor 1302. In some embodiments, one or more fastener cutouts

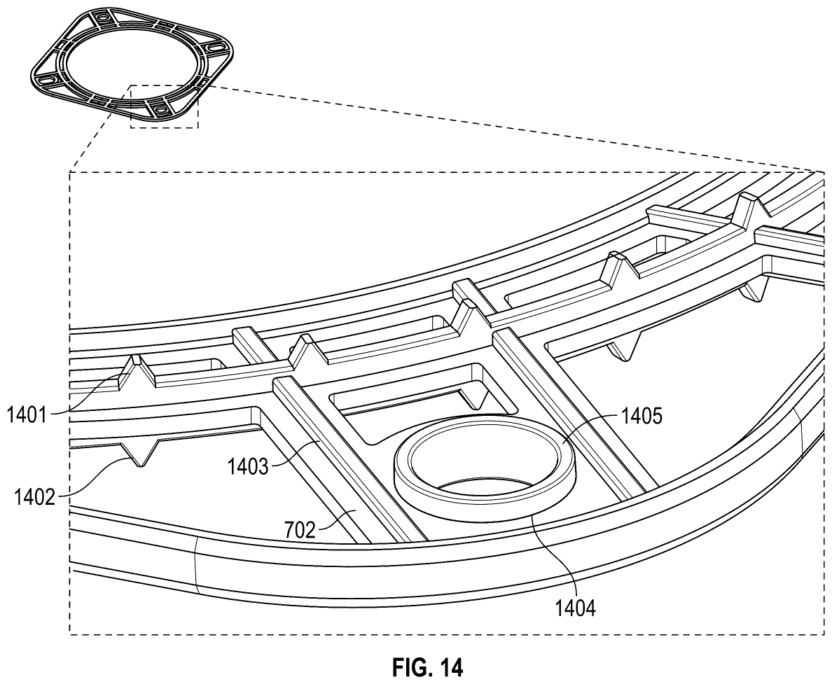

FIG. 14 illustrates a spacer which includes one or more gripping embossments according to some embodiments. In some embodiments, a rigid spacer and/or a gapped spacer includes one or more gripping embossments which comprises raised structural features configured to engage at least a portion of a gasket face. In some embodiments, one or more seal rings 602, 603, 604 704, 705, 706 comprise one or more gripping embossments 1401, 1402, 1403, 1404. In some embodiments, one or more gripping embossments include a top spiked projection 1401 and/or a bottom spiked projection 1402. In some embodiments, one or more mounting bridges 702 include one or more elongated projections 1403. In some embodiments, one or more spacer fastener cutouts 1404 include one or more perimeter projections 1405. While the non-limiting illustrated example in FIG. 14 shows gripping embossments integral to a gapped spacer, some embodiments of any spacer described herein include gripping embossments. In some embodiments, gripping embossments substantially prevent gaskets, placed above and below the spacer and having direct contact with the spacer from any significant lateral movement relative to the spacer.

The subject matter described herein is directed to technological improvements to the field of toilet installation by providing a system to seal a toilet discharge when there is a gap between the bottom of the toilet and a floor flange. The systems and methods described herein were unknown and/or not present in the public domain at the time of filing, and they provide technologic improvements and advantages not known in the prior art.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein. As a non-limiting example, the spacers shown in FIGS. 6 and 7 are interchangeable with any combination of gaskets described herein and/or may be used in combination with each other when creating a discharge assembly comprising multiple spacers according to some embodiment.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

As used herein, “can” or “may” or derivations there of (e.g., the system can be arranged as follows) are used for descriptive purposes only and is understood to be synonymous and/or interchangeable with “configured to” (e.g., the system is configured to be arranged as follows) when defining the metes and bounds of the system. The phrase “configured to” also denotes the step of configuring a structure to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Although method operations may be presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

We claim:

1. A system for sealing a toilet bowl discharge comprising:
a first gasket,
a spacer, and
a second gasket.

2. The system of claim 1,
wherein the system is configured to create a seal between the toilet bowl discharge and a floor flange when system is assembled with the spacer between the first gasket and the second gasket.

3. The system of claim 2,
wherein the spacer comprises a stiffness greater than the first gasket and the second gasket.

4. The system of claim 2,
wherein the first gasket is thicker than the second gasket.

5. The system of claim 3,
wherein the first gasket comprises two gaskets stacked on each other.

6. The system of claim 2,
wherein the spacer comprises one or more spacer sidewalls; and
wherein the one or more spacer sidewalls are configured to define a recess;
wherein one or more spacer sidewalls are configured to at least partially surround and/or overlap one or more gasket sidewalls.

7. The system of claim 2,
wherein the spacer comprises one or more ribs; and
wherein the one or more ribs extend around a perimeter of the spacer.

8. The system of claim 7,
wherein the one or more ribs define one or more rings on a surface of the spacer.

9. The system of claim 8,
wherein the one or more rings include a discharge seal ring, an intermediate seal ring, and a perimeter seal ring.

10. The system of claim 8,
wherein the first gasket and/or the second gasket is configured to at least partially deform to a shape of the one or more rings.

11. The system of claim 7,
wherein the spacer comprises one or more gaps.

12. The system of claim 11,
wherein the one or more gaps are configured to enable the first gasket to contact the second gasket when the spacer is in between the first gasket and the second gasket.

13. The system of claim 2,
wherein at least one of the first gasket, the second gasket, and the spacer comprises a bowl discharge cutout comprising a funnel shape.

14. The system of claim 2,
wherein the first gasket, the second gasket, and the spacer each comprises one or more fastener cutouts which are aligned when the spacer is assembled between the first gasket and the second gasket.

15. A kit for creating a discharge seal assembly comprising:
a first gasket,
a spacer, and
a second gasket.

16. The kit of claim 15,
wherein the spacer comprises a spacer outer perimeter that includes a shape that is substantially similar to both a first gasket outer perimeter of the first gasket and a second gasket outer perimeter of the second gasket.

17. The kit of claim 15,
wherein the first gasket, the spacer, and the second gasket are configured to be stacked together to create a seal for a toilet discharge.

18. The kit of claim 17,
further including shims configured to stabilize a toilet installed on an uneven floor.

19. The kit of claim 16,
further including a third gasket;
wherein the third gasket includes a third gasket outer perimeter shape with a different shape than the first gasket outer perimeter and the second gasket outer perimeter; and
wherein the first gasket, the spacer, and the third gasket are configured to be stacked together to create a seal for a toilet discharge.

20. The kit of claim 16,
wherein the first gasket comprises a different thickness than the second gasket.
